(19) United States
(12) Patent Application Publication
(10) Pub. No.: US 2024/0041056 A1
(43) Pub. Date: Feb. 8, 2024

(54) AN APPARATUS FOR TRIMMING AND CUTTING FOOD ITEMS

(71) Applicant: Lambhusasund EHF., Akranes (IS)

(72) Inventor: Ingolfur ARNASON, Akranes (IS)

(21) Appl. No.: 18/257,072

(22) PCT Filed: Dec. 13, 2021
(86) PCT No.: PCT/IS2021/050012

§ 371 Date: Jun. 12, 2023

(30) Foreign Application Priority Data
Dec. 11, 2020 (IS) IS 050330

(51) Int. Cl. A22C 17/00; B25J 11/00; A22C 25/18; A22C 25/08

(52) U.S. Cl. CPC A22C 17/0073; A22C 17/0093; B25J 11/0045; A22C 25/18; A22C 25/08

(57) ABSTRACT

The present invention provides a new method and apparatus for performing water jet cutting of food items on conveyor belts. The invention provides a cutting unit with a novel design and a method for the use of plurality of cutting devices for cutting, trimming and removing undesired tissue from food items in a more accurate but faster way than prior art methods.

### FIELD OF THE INVENTION

The invention provides a device and method for trimming and cutting food items, for portioning food items and for removing undesired tissue with precision. Furthermore, the present invention provides a method and device for using water jet devices to portion and trim food items using image date for determining cutting patterns.

### BACKGROUND

Automatic processing of food items, such as, trimming, portioning and pin-bone removal is a demanding task for the food industry and has been for a long time. Early techniques focused on storing the fish for several days after slaughtering or even freezing before processing. This was considered beneficial for pin-bone removal in order to allow the flesh to detach from the bones. The requirement of delivering fresh food items to the market has driven development in cooling and freezing process, which in combination with automation of most processing steps has resulted in better quality foot items available in much shorter time from slaughtering.

Water jet cutting is a common method for cutting or trimming food items such as chicken or breasts or fish fillets. Separation of food products, such as fish fillets, chicken fillets, and many others, is known in the art. U.S. Pat. No. 4,962,568 discloses how food products are cut to predetermined portion sizes or to predetermined profile shapes, by scanning the items with a camera capable as they move on a conveyor. The camera provides a programmed computer with dimensional data and utilizes the computer to control the operation of a plurality of high-pressure water jet cutters to cut the food products to reduced sizes as dictated by the computer program.

WO 2006/064521 A1 discloses a method for automatically cutting pin bones from super chilled fish fillets using water jet devices, where removal of pin-bones and other undesired tissue is based on imaging and comparison to an array of cutting patterns and thereafter selecting one cutting pattern based on the image comparison and cutting according to the selected cutting pattern.

### SUMMARY OF THE INVENTION

The present invention provides a system, a method and an apparatus for trimming and/or cutting food items. The invention disclosed herein provides an improvement over prior art devices in that a cutting unit comprising a set of water jet devices is used for cutting the food items, where one water jet device is defined as a master cutting device and one or more secondary or supplementary water jet devices are arranged to rotate around the master jet device during trimming and/or cutting a food item.

The present invention uses computing means for operating the cutting unit giving operating instructions to each water jet cutting devices. The master water jet device performs a base cut in each food item, whereas the position of the secondary water jet devices is adjusted with a possibility of a rotation around the master jet device to alter or fine-tune second cuts into the food items based on criteria such as size and orientation to deliver portions of desired size and/or weight or to deliver more precise trimming and cutting of food items.

In some embodiments one or more imaging devices are used to obtain images of the food items prior to portioning, trimming or removal of undesired tissue. An imaging devise may obtain volumetric data of a food item, where the computing means determines the cutting pattern based on desired size and or weight of portions. Thereby, a larger food item is cut in a different manner than smaller food items to obtain similar size or weight cuts. Imaging devices may be used to determine shape of food items to be cut, where computing devices determine a cutting pattern based on calculations or pre-defined cutting patterns for different shape and sized food items. Imaging means may also be used to detect undesired tissue such as fat, cartilage, or bones etc, where the computing device process the image data to identify such undesired tissue and issue operating instructions for the cutting unit to perform cuts, such that the undesired tissue can be removed.

In some embodiments means for determining position and/or orientation of the food items on a conveyor belt, where real-time position on a conveyor can be determined at all times. Such data may be used to calculate cutting patterns and to accurately operate the cutting unit.

In some embodiments the food items are undercooled prior to cutting or trimming. The cooling may be performed by the “SUB CHILLING” process in cooling devices using a salt controlled and temperature-controlled solution to bring the food items into the phase transition of freezing to an undercooled state. This cooling process renders the food items firmer and better suited for cutting by water jet devices.

In some embodiments the food items are form-fixed prior to cutting or trimming. Food items may be form-fixed in a device which uses a thermal conductive conveyor belt passing through a chilled solution as it returns to the in-feeding end. This method and device is used for bringing the food items into the phase transition of freezing by cooling down the surface of the food items in contact with the conveyor belt without freezing the surface or forming in ice-shell around the food items. In some embodiments, the form-fixing device comprises a thermal chamber having a conveyor for conveying the product items in the chamber and a liquid container at the bottom of the chamber containing a chilled salt solution. This renders the conveyor to be cooled down to temperatures way below 0° C. to provide contact cool down of the surface of the food items as the conveyor belt rises from the liquid bed and enters it transport orientation and facilitates contact cooling of the food items.

In some embodiments thermal form-fixing and x-ray imaging of food items is performed to provide the option of removing more accurately undesired tissue, such as bones and fat from the flesh in processing food items. By providing a method and device for using a cutting unit with a master jet cutting device and secondary jet cutting devices rotating around the master jet device, accurate cuts can be made in one motion of the conveyor belt and the cutting unit to perform several cuts saving time but maintaining accuracy. X-ray imaging of food items on conveyors needs to be performed on solid and flat surfaces of such conveyor whereas the water-jet cutting is performed on porous surface conveyor belts, which requires transfer of the food items from one blet to another. This transportation may cause shifting or movement of the undesired tissue withing the flesh in fresh food items, which requires second imaging and computer corrections prior to cutting. By using form-fixing, such corrections are not needed and a cooling step to brength food items in the phase transition of freezing is initiated.

In some embodiments the cutting unit uses a master waterjet cutting device and one or more secondary water jet cutting devices, which are arranged to rotate around the master water-jet cutting device on a single robotic arm. Each of the water jet cutting devices may comprise one to six degrees of freedom movement in order to cut into the food items at all angles.

It is an object of the present invention to overcome or ameliorate the aforementioned drawbacks of the prior art and to provide an improved and/or alternative and/or additional apparatus and method for cutting and/or trimming food items using water jet cutting devices. It is one preferred object of the present invention to provide a method and device for using two or more waterjet cutting devices in a single cutting unit, where one water jet device is defined as a master jet device and the one or more secondary water jet devices rotate around the master jet device during performing cuts into the food items (in a single movement of a robotic arm). In one preferred object of the present invention an apparatus and method for using vision means and a processing device for determining cutting patterns of food items based on size and shape for cutting with a cutting unit of the present invention. Moreover, it is a preferred object of the present invention to provide an apparatus and a method for cutting and/or trimming food items using positioning and orientation data. Furthermore, it is a preferred object of the present invention to provide an apparatus and a method for processing food items by using the waterjet cutting unit presented herein on “SUB-CHILLED” or form-fixed food items.

The object(s) underlying the present invention is (are) particularly solved by the features defined in the independent claims. The dependent claims relate to preferred embodiments of the present invention. Further additional and/or alternative aspects are discussed below.

Thus, at least one of the preferred objects of the present invention is solved by an apparatus for cutting and/or trimming food items, where the apparatus comprises i) a processing conveyor belt adapted to receive food items for cutting and/or trimming, ii) a cutting unit further comprising a first water jet cutting device and one or more secondary water jet cutting devices, and iii) computing means. The first water jet cutting device and the one or more second water jet cutting device of the cutting unit are operated by the computing means where the one or more second water jet cutting devices are arranged to rotate around the first water jet cutting device during cutting and/or trimming food items on the processing conveyor belt.

One of the preferred objects of the present invention is solved by a system for cutting and/or trimming food items, where the system comprises i) processing conveying means for receiving and advancing food items for cutting and/or trimming, ii) a cutting unit for cutting and/or trimming the food items where the cutting unit further comprises a) a first water jet cutting device, and b) one or more secondary water jet cutting devices, and iii) computing means for giving operating instructions to the first water jet cutting device and the one or more second water jet cutting device of the cutting unit, where the one or more second water jet cutting devices are arranged to rotate around the first water jet cutting device during cutting and/or trimming food items on the processing conveying means.

One of the preferred objects of the present invention is solved by a method for cutting and/or trimming food items, where the method comprising the steps of:
a) transferring the food items on a processing conveyor,
b) performing processing steps for cutting and/or trimming the food items on the processing conveyor using a cutting unit, said cutting unit further comprises—
   a first water jet cutting device,
   one or more second water jet cutting devices, and
c) issuing operating instructions by a computing means to the cutting unit, where independent operating instructions are issued for the first water jet cutting device and the one or more second water jet cutting device.

The first water jet cutting device and the one or more second water jet cutting device of the cutting unit are operated by the computing means, and the one or more second water jet cutting devices are arranged to rotate around the first water jet cutting device during cutting and/or trimming food items on the processing conveying means.

One of the preferred objects of the present invention is solved by a system for detecting and removing undesired tissue from food items, the apparatus comprising:
a) imaging conveying means for conveying food items to an imaging device for obtaining image data of the food items,
b) first computing means for processing the image data of the food items to determine cutting and/or trimming pattern for the food items,
c) processing conveying means for receiving and advancing food items for cutting and/or trimming,
d) positioning means for obtaining real-time position and orientation data of the food items on the processing conveying means,
e) cutting means for cutting and/or trimming the food items where the cutting means further comprises:
   a first water jet cutting device, and
   one or more second water jet cutting devices,
f) second computing means for:
   i) processing the position and the orientation data for the food items on the processing conveying means and comparing it to the processed image data, and
   ii) for giving operating instructions to the first water jet cutting device and the one or more second water jet cutting device of the cutting means based on the data comparison, and
g) arranging the one or more second water jet cutting devices to rotate around the first water jet cutting device on the cutting means during cutting and/or trimming of the food items on the processing conveying means.

### DESCRIPTION OF THE INVENTION

In the present context the term “food items” refers to fish or parts of fish such as fillets, from fish such as but not limited to salmon, trout, cod, haddock, pollock, catfish, ling, blue ling, tusk, monkfish, carp, bass, bream, turbot, sea bass, sole, milkfish, grey mullet, grouper, sea bream, halibut, flounder, Japanese flounder, or chicken or parts of chicken and meet products from beef, pork and sheep/lamb.

In the resent context the term “undesired tissue” refers to any tissue of food items not intended for further processing, such as bones, fat and cartilage.

In the resent context the term “removing undesired tissue from the form-fixed food items” refers to processing steps such as cutting using water jet devices.

In the resent context the terms “cutting” and “trimming” refer to processing steps such as cutting using water jet devices to make cuts into or through food items for portioning and/or trimming.

In the resent context the terms “form-fixing” and “thermal form-fixing” both refer to cooling the food items on a conveyor belt which is covered with salt-solution for providing surface cooling and stiff food items without forming a crust or ice-shell on the surface of the food items.

In the present context the term “SUB-CHILLING™” or “under-cooling” refers to the process or method of bringing fish to a desired temperature at or near the phase transition of freezing the fish without freezing the fish, and generally below the freezing point of water (0° C.). Furthermore, these terms refer to a fish or fish product being brought to or kept at a desired temperature at or near the phase transition of freezing the fish without freezing the fish, such as a temperature below 0° C. (sub-zero conditions).

In the resent context the terms “computing means”, “processing means” and “processor” all refer to means or devices to computing devices with a processor for processing data, executing software, calculation and giving instructions. These terms can be used for an industrial computer together with a data processing computer.

In the present context the term “six degrees of freedom” refers to the freedom of movement of a device, such as a water jet, in three-dimensional space and being free to change position as forward/backward, up/down, left/right.

In the present context the term “waterjet cutting device” refers to cutting devices where high-pressure water stream is focused into a beam or water jet by a nozzle.

In the present context the term “operating instructions” refers to providing communication to the cutting unit on how to perform cutting into each food item as it is conveyed on a processing conveyor, such as to cut around bones or other undesired tissue, or such as to perform portioning cuts.

In an embodiment of the present invention the conveying means or conveyor belts, such as a processing conveyor or an imaging conveyor comprises an elongated conveyor belt for advancing or moving food items from an infeed end to an outfeed end.

In an embodiment of the present invention, the imaging conveyor comprises an endless conveyor belt made from solid material.

In an embodiment of the present invention, the processing conveyor comprises an endless conveyor belt made from porous material.

In an embodiment of the present invention, the processing conveyor belt may comprise conveying surface made from metal, such as steel.

In an embodiment of the present invention the first water jet cutting device and the one or more second water jet cutting device of the cutting unit comprises a high-pressure water jet nozzle.

In an embodiment of the present invention the first water jet cutting device and the one or more second water jet cutting device of the cutting unit are arranged/positioned on a single robotic arm.

In an embodiment of the present invention each water jet cutting device comprises one to six degrees of freedom movement.

In an embodiment of the present invention the diameter of the aperture of each water jet cutting device is adjustable. In such an embodiment the diameter of the water jet cutting device may be adjusted or altered between or during cutting operations.

In an embodiment of the present invention each water jet cutting device may be switched on and off during cutting and/or trimming of each food item. This may be facilitated using a valve for each water jet cutting device.

In an embodiment of the present invention each water jet cutting device may be regulated to provide varying water pressure during cutting of a food item.

In an embodiment of the present invention a positioning means is provided which is adapted to obtain real-time position and orientation data of the food items on the processing conveyor.

In an embodiment of the present invention the positioning means further comprises one or more of i) an imaging device, ii) an encoder, and iii) computing means.

In an embodiment of the present invention a cooling device is provided for undercooling for bringing the food items to an undercooled state, where cooling device comprises i) a chamber for cooling food items in liquid, and ii) means for agitating the food items during the cooling process. In such an embodiment the food items are brought to an undercooled state bay agitation in a salt controlled and temperature-controlled solution prior to cutting/and or trimming.

In an embodiment of the present invention a thermal form-fixing device is provided for stiffening and/or fixing the form of the food items by contact cooling of the food items prior to cutting/and or trimming. In such an embodiment the thermal form-fixing device may further comprises: i) a thermal chamber, ii) a conveyor belt within the thermal chamber, said conveyor belt forming an endless loop with a processing part and an idling part, and iii) a liquid container below said conveyor belt, where the idling part of said conveyor belt passes through a liquid containing portion of the thermal container.

In an embodiment of the present invention the first water jet cutting device is defined as a master cutting device, and the operating instructions for the one or more secondary water jet cutting devices involve rotating the one or more secondary water jet cutting devices around the master cutting device to bring them into and maintaining their cutting position.

In an embodiment of the present invention an imaging conveying means is provided, which is arranged and adapted to advance food items on and deliver food items to the processing conveying means. In such an embodiment a first imaging means is provided to obtain first image data of food items on the imaging conveying means.

In an embodiment of the present invention the computing means processes the image data to determine a cutting pattern for the cutting unit.

In an embodiment of the present invention the first imaging means comprises an x-ray device positioned to obtain x-ray image data of food items on the imaging conveying means.

In an embodiment of the present invention the computing means uses the x-ray images to identify and position undesired tissue in the food items, where the computing means determines processing steps for removing undesired tissue from the food items.

In an embodiment of the present invention the computing means is configured to compare the position of the undesired tissue in the X-ray images to the real-time position and orientation data of the food items on the processing conveying means to give operating instructions to the cutting unit for removing undesired tissue in the food items.

In an embodiment of the present invention the x-ray device comprises one or more x-ray sources.

In an embodiment of the present invention the computing means is configured to compare the position and the orientation of the food items on the processing conveying means to the image data prior to sending operating instruction to the cutting unit.

In an embodiment of the present invention the first image data comprises volumetric/size data of the food items.

In an embodiment of the present invention the volumetric/size data of the food items is used for determining portion cutting of food items and wherein the operating instructions for the one or more second water jet cutting devices are determined by the position of the first water jet cutting device to obtain portion cutting of the food items by a pre-defined criteria.

In an embodiment of the present invention the apparatus or system further comprises a second imaging device for obtaining second image data.

In an embodiment of the present invention the first imaging device comprises an x-ray device and the second imaging device comprises other imaging means such as digital imaging means, 2D and/or 3D imaging means for obtaining volumetric data, colour data, etc.

In an embodiment of the present invention the computing means is adapted to processes the image data to determine a cutting pattern for the cutting unit based on image data from the first and/or second imaging device.

In an embodiment of the present invention the processing means uses the volumetric/size data to maintain a constant distance between the cutting unit and the food item during cutting.

In an embodiment of the present invention the processing means uses the volumetric/size data to determine the speed of movement of the cutting unit in relation to the thickness of the food items.

In an embodiment of the present invention the computing means gives operating instructions to the cutting unit based on pre-defined cutting patterns, which may be based on size and/or shape.

In an embodiment of the present invention the computing means uses the processed position and the orientation data to determine a cutting pattern for the cutting unit based on pre-defined cutting patterns.

In an embodiment of the present invention image processing, operating the cutting unit and position/orientation determination is performed by same or separate computing means.

In an embodiment of the present invention one or more computing devices are used; i) for giving operating instructions, ii) for processing image data to determine a cutting pattern for the cutting unit, iii) to identify and position undesired tissue in the food items, iv) to determine processing steps, and v) to compare the position and the orientation of the food items on the processing conveying means to image data and to give operating instructions based on the comparison.

In an embodiment of the present invention, the food items are transported from the conveyor of the thermal form-fixing device to the imaging conveyor and subsequently from the imaging conveyor to the processing conveyor, and wherein the system further comprises positioning means to determine the position of the food items on the processing conveyor for accurate removal of undesired tissue from the form-fixed food items.

In an embodiment of the present invention, the apparatus further comprises a second imaging device for obtaining image data, such as digital image data, of the food items on the imaging conveyor.

In an embodiment of the present invention, x-ray images from a plurality of x-ray sources are used for determining the position undesired tissue in the form-fixed food items.

### Description of Various Embodiments

The present invention will become more fully understood from the detailed description given hereinafter and the accompanying drawings which are given by way of illustration only, and thus, are not limitative of the present invention, and wherein:

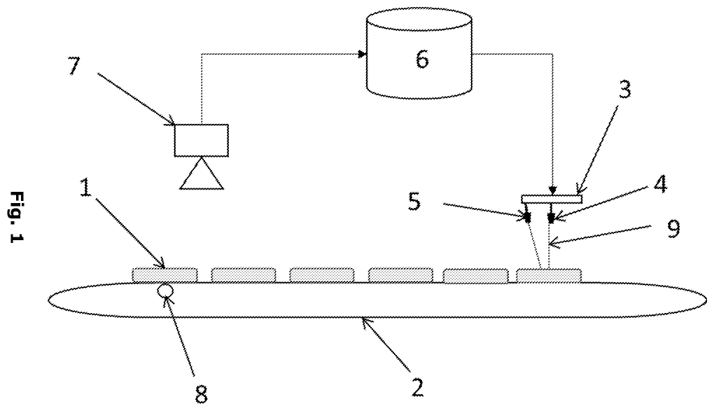

FIG. 1 outlines the apparatus, system and method of the present invention in one embodiment showing food items 1 being transported on a processing conveyor 2. The food items are cut or trimmed using a cutting unit 3 further comprising water jet cutting devices. In the embodiment shown in FIG. 1, the cutting unit comprises a master waterjet cutting devices 4 and one secondary waterjet cutting device 5. The secondary waterjet cutting device 5 is arranged to be rotatable around the master waterjet cutting devices 4. A computer device 6 operates the cutting unit and controls the movement of the cutting devices 4, 5 and thereby the direction of the waterjet 9 as well as turning the waterjet on and off during the cutting process. The position and orientation of the food items 1 on the processing conveyor 2 is determined by positioning and imaging devices such as a computer 6 and a vision system 7 in combination with an encoder 8. The vision system 7 nay obtain images of the food items to be processed by the computing device 6 to determine a cutting pattern for each food item 1

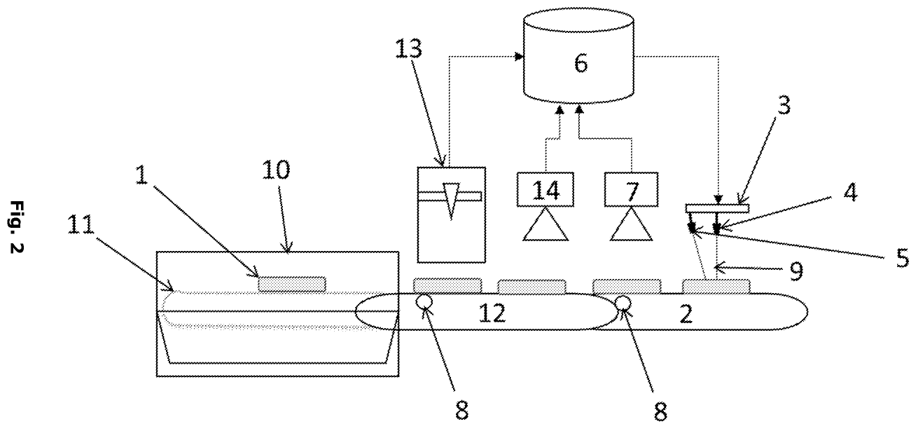

FIG. 2 is an overview of an apparatus according to one embodiment of the present invention using several imaging systems to determine processing steps for food items. In this embodiment the, the apparatus is based on transferring the food items 1 on conveyors through the form-fixing, imaging steps and the processing of the food items. A thermal form-fixing device 10 is used to stiffening the food items by cooling down the surface of the food items in contact with the conveyor belt, without freezing the surface of the food items or forming in ice-shell around the food items. The form-fixing device has a conveyor belt 11 as is disclosed in FIG. 1, which delivers form-fixed food items to an imaging conveyor 12 for image analysis and determination of processing steps. An x-ray device 13 is positioned above the imaging conveyor 12 to obtain x-ray images of food items 1 on the imaging conveyor 12 which may be processed by the computer 6 and used to determine position of on undesired tissue in the food items. In this embodiment a second imaging device 14 is shown, which may obtain second image data, such as colour digital images or 3D data, where the data is processed by the computer 6 for further location of undesired tissue and/or to produce volumetric date for trimming and portioning food items. Thereafter, the form-fixed food items are transferred onto a processing conveyor 2 adapted to receive food items from the imaging conveyor 12. The computing device 6 may use the x-ray data and combine with data from the second imaging device 14 to determine processing steps performed by the cutting unit 3. A positioning device 7, 8 obtains position data of the form-fixed food items 1 on the processing conveyor 2 and optionally also the imaging conveyor 12. The computing device 6 compares the X-ray images data and optionally the second image data to the position data of the food items 1 on the processing conveyor to determine issue cutting instructions based on the processed data. The cutting unit may be removing undesired tissue from the form-fixed food items and/or trimming and portioning the form-fixed food items using the waterjet devices of the cutting unit 3. As the positioning device 7, 8 can provide the computing means 6 with accurate position and orientation of the food items on the processing conveyor 2, the computing means can determine accurate cutting steps by comparing the image data to the position and orientation data. The two water jets 9 can cut simultaneously or one at the time. As the secondary waterjet cutting device 5 can rotate around the master waterjet cutting device 4, the form-fixed food items can be cut in one motion of a single cutting unit 3 which saves time, space and equipment cost.

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components.

The present invention also covers the exact terms, features, values and ranges etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

The term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

It will be appreciated that variations to the foregoing embodiments of the invention can be made while still falling within the scope of the invention can be made while still falling within scope of the invention. Features disclosed in the specification, unless stated otherwise, can be replaced by alternative features serving the same, equivalent or similar purpose. Thus, unless stated otherwise, each feature disclosed represents one example of a generic series of equivalent or similar features.

Use of exemplary language, such as “for instance”, “such as”, “for example” and the like, is merely intended to better illustrate the invention and does not indicate a limitation on the scope of the invention unless so claimed. Any steps described in the specification may be performed in any order or simultaneously, unless the context clearly indicates otherwise.

All of the features and/or steps disclosed in the specification can be combined in any combination, except for combinations where at least some of the features and/or steps are mutually exclusive. In particular, preferred features of the invention are applicable to all aspects of the invention and may be used in any combination.

1. An apparatus for cutting and/or trimming food items, the apparatus comprising:
a processing conveyor belt adapted to receive food items for cutting and/or trimming,
a cutting unit, said cutting unit, further comprising
a first water jet cutting device,
one or more second water jet cutting devices, and
computing means,
wherein the first water jet cutting device and the one or more second water jet cutting device of the cutting unit are operated by the computing means
characterized in that the one or more second water jet cutting devices are arranged to rotate around the first water jet cutting device during cutting and/or trimming food items on the processing conveyor belt.

2. The apparatus according to claim 1, wherein the first water jet cutting device and the one or more second water jet cutting device, of the cutting unit are arranged/positioned on a single robotic arm.

3. The apparatus according to claim 1, wherein each water jet cutting device comprises one to six degrees of freedom movement.

4. The apparatus according to claim 1, wherein the diameter of the aperture of each water jet cutting device is adjustable.

5. The apparatus according to claim 1, wherein the diameter of the aperture of each water jet cutting device can be adjusted or altered between or during cutting operations.

6. The apparatus according to claim 1, wherein each water jet cutting device can be switched on and off during cutting and/or trimming of each food item.

7. A system for cutting and/or trimming food items, the system comprising:
a processing conveying means for receiving and advancing food items for cutting and/or trimming,
a cutting unit for cutting and/or trimming the food items where the cutting unit further comprises
a first water jet cutting device,
one or more second water jet cutting devices, and
computing means for giving operating instructions to the first water jet cutting device and the one or more second water jet cutting device of the cutting unit,
characterized in that the one or more second water jet cutting devices are arranged to rotate around the first water jet cutting device during cutting and/or trimming food items on the processing conveying means.

8. The system according to claim 7, wherein the system further comprises a positioning means adapted to obtain real-time position and orientation data of the food items on the processing conveying means.

9. The system according to claim 7, wherein the system further comprises a first imaging means for obtaining first image data of the food items on the processing conveying means and/or on an imaging conveying means.

10. The system according to claim 9, wherein the computing means processes the first image data to determine a cutting pattern for the food items.

11. The system according to claim 9, wherein the first imaging means comprises an x-ray device to identify and position undesired tissue in the food items.

12. The system according to claim 11, wherein the computing means is configured to compare the position of the undesired tissue in the X-ray images to the real-time position and orientation data of the food items on the processing conveying means to give operating instructions to the cutting unit for removing undesired tissue in the food items.

13. The system according to claim 7, wherein the system further comprises a second imaging means for obtaining second image data of the food items on the processing conveying means and/or on an imaging conveying means.

14. The system according to claim 13, wherein the second image data comprises volumetric/size data of the food items.

15. The system according to claim 14, wherein the processing means uses the volumetric/size data to maintain a constant distance between the cutting unit and the food item during cutting.

16. The system according to claim 14, wherein the processing means uses the volumetric/size data to determine the speed of movement of the cutting unit in relation to the thickness of the food items.

17. The system according to claim 14, wherein the volumetric/size data of the food items is used for determining portion cutting of food items, and wherein the operating instructions for the one or more second water jet cutting devices are determined by the position of the first water jet cutting device to obtain portion cutting of the food items by a pre-defined criteria

18. The system according to claim 7, wherein the system further comprises a thermal form-fixing means for bringing the food items into the phase transition of freezing contact cooling of the food items prior to cutting/and or trimming.

19. The system according to claim 7, wherein the system further comprises means for bringing the food items to an undercooled state by agitation in a salt controlled and temperature-controlled solution prior to cutting/and or trimming.

20. A method for cutting and/or trimming food items, the method comprising the steps of:
a) transferring the food items on a processing conveyor,
b) performing processing steps for cutting and/or trimming the food items on the processing conveyor using a cutting unit, said cutting unit further comprises
a first water jet cutting device,
one or more second water jet cutting devices, and
c) issuing operating instructions by a computing means to the cutting unit, where independent operating instructions are issued for the first water jet cutting device and the one or more second water jet cutting device,
wherein the first water jet cutting device and the one or more second water jet cutting device of the cutting unit are independently operated by the computing means,
characterized in that the one or more second water jet cutting devices are arranged to rotate around the first water jet cutting device during cutting and/or trimming food items on the processing conveying means.
